(19) United States
(12) Patent Application Publication
(10) Pub. No.: US 2005/0065221 A1
(43) Pub. Date: Mar. 24, 2005

(54) Emulsifier mixture

(76) Inventors: Karl Heinz Schmid, Mettmann (DE); Ute Lemke, Neuss (DE); Dirk Mampe, Duesseldorf (DE); Karlheinz Hill, Erkrath (DE); Norbert Huebner, Langenfeld (DE)

Correspondence Address: COGNIS CORPORATION;PATENT DEPARTMENT, 300 BROOKSIDE AVENUE, AMBLER, PA, 19002, US

(21) Appl. No.: 10/495,886

(22) PCT Filed: Nov. 11, 2003
(86) PCT No.: PCT/EP02/12560

(30) Foreign Application Priority Data
Nov. 19, 2001 (DE) 101 56 285.3

(51) Int. Cl. B01F 17/00

(52) U.S. Cl. 516/77

(57) ABSTRACT

An emulsifier composition containing: (a) from about 0.5 to 90% by weight of an isoalkenyl oligoglycoside; (b) from about 0.5 to 90% by weight of an isoalkenyl fatty alcohol; (c) up to about 10% by weight, water; and (d) optionally, from about 0.1 to 30% by weight of a hydrophilic wax, all weights being based on the weight of the composition.

### FIELD OF THE INVENTION

This invention relates to emulsifier compounds with a defined content of branched unsaturated fatty alcohols and isoalkenyl (oligo)glycosides and to the use of the emulsifier compounds for the production of cosmetic and/or pharmaceutical preparations and as lipid layer enhancers in cosmetic and pharmaceutical preparations.

### PRIOR ART

Consumers expect cosmetic skin- and hair-care emulsions to satisfy a range of requirements. Apart from the cleaning and skin-/hair-care effects which determine the intended application, value is placed on such diverse parameters as very high dermatological compatibility, good lipid-layer-enhancing properties, elegant appearance, optimal sensory impression and stability in storage.

Preparations used for the cleaning and care of human skin generally contain one or more surface-active substances, more particularly based on anionic or amphoteric surfactants. Since the use of surfactants on their own would cause excessive drying out of the skin and hair, it is standard practice to add lipid layer enhancers to corresponding preparations. It is obvious that these substances are expected not only to have an adequate lipid-layer-enhancing effect, but also—in line with market requirements—to exhibit optimal dermatological compatibility.

German Patent DE-C2 41 39 935 describes liquid water-based body shampoos which contain 5 to 35% by weight anionic surfactants, 2.5 to 15% by weight alkyl polyglucosides and 0.5 to 15% by weight saturated fatty acid monoglycerides containing 8 to 18 carbon atoms in the fatty acyl group. However, the monoglycerides proposed in this document show unsatisfactory dermatological compatibility, even in admixture with glucosides. In addition, the mixtures are generally solid in the absence of water and, hence, are not easy to process without heating.

German patent application DE-A 27 01 266 describes foam bath compositions containing 1 to 50% by weight fatty acid monoglycerides and 5 to 50% by weight alkyl sulfates, alkyl ether sulfates and/or ether carboxylic acid salts. However, these mixtures do not have any advantageous lipid-layer-enhancing properties.

European patent EP-B1 0 554 292 describes o/w emulsions containing oil components, alkyl polyglucosides, fatty acid partial glycerides and optionally fatty alcohols. These mixtures also are not entirely satisfactory in regard to their lipid-layer-enhancing effect, their dermatological compatibility and their consistency in water-free form.

Finally, European patent application EP-A1 0 538 762 describes hair treatment preparations containing cationic surfactants, alkyl polyglucosides and oil components, for example even fatty acid monoglycerides, which are said to impart softness and elasticity to the hair.

European Patent EP-B1 0 553 241 describes the use of self-emulsifiable mixtures of 10 to 40% by weight alkyl oligoglucosides, 60 to 90% by weight fatty alcohols and optionally polyglucose for the production of emulsions. According to the teaching of International patent application WO 97/18033, an emulsifier concentrate of 43 to 90% by weight alkyl and/or alkenyl oligoglycosides and 10 to 57% by weight fatty alcohols may be used for the production of cosmetic emulsifiers. These compositions do not have advantageous lipid-layer-enhancing properties and are also solid so that they cannot be processed without heating.

The problem addressed by the present invention was to provide emulsifier concentrates (compounds) liquid at room temperature for the production of cosmetic products which, besides favorable surface-active properties, would also have good lipid-layer-enhancing and thickening properties. The emulsifier concentrates would be stable in storage, would be of a suitable color for cosmetic applications and would be able to be incorporated particularly easily in cosmetic preparations by processes involving no heating.

### DESCRIPTION OF THE INVENTION

It has been found that emulsifier concentrates containing branched, unsaturated fatty alcohols and isoalkenyl (oligo)glycosides are liquid at room temperature and can be incorporated particularly easily in emulsions by so-called cold processes, show high dermatological compatibility and optimal lipid-layer-enhancing properties and are highly stable in storage. Another advantage is that the mixtures build up a viscosity in surfactant-containing systems.

Accordingly, the present invention relates to emulsifier concentrates containing:
(a) 0.5 to 90% by weight of at least one isoalkenyl oligoglycoside,
(b) 0.5 to 90% by weight of at least one isoalkenyl fatty alcohol and
(c) 0 to 10% by weight of water.

The isoalkenyl groups of the oligoglycoside and the fatty alcohol are preferably identical.

The present invention also relates to the use of the emulsifier concentrates according to the invention for the production of cosmetic or pharmaceutical preparations and as lipid layer enhancers in cosmetic or pharmaceutical preparations.

The emulsifier concentrates according to the invention have the advantage that they develop a strong emulsifying effect by virtue of their long alkyl chain and, despite this long alkyl chain, are liquid to a temperature of 5° C. and hence can be processed without heating. In addition, the emulsifier concentrates according to the invention are more stable to oxidation compared with linear unsaturated alcohols and, hence, give better color qualities. This is particularly important for use in the cosmetics field where decomposition-related discoloration is totally unacceptable and the resulting secondary products can even lead to dermal irritation. The lipid-layer-enhancing properties are also better by comparison with mixtures based on saturated and/or unbranched alcohols.

The concentrates may contain small quantities, but usually never more than 15%, of oses, polyoses, water and other secondary reaction products from their production. Their water content is at most 10% by weight and preferably below 5% by weight, based on the emulsifier concentrates. Water-free emulsifier concentrates are particularly preferred. Water-free emulsifier concentrates in the context of the invention are concentrates which merely contain residual quantities of water from the raw materials used, but no added water.

The content of isoalkenyl oligoglycoside or isoalkenyl fatty alcohol predominates according to the application envisaged. If lipid-layer-enhancing properties are paramount, the percentage content of isoalkenyl fatty alcohol selected for the concentrate will be higher. By contrast, for emulsifying properties, the content of isoalkenyl oligoglycoside will be higher.

The concentrate preferably contains (a) 15 to 80% by weight of at least one isoalkenyl oligoglycoside, (b) 20 to 85% by weight of at least one isoalkenyl fatty alcohol and (c) 0 to 10% by weight of water. A preferred embodiment of the concentrate contains (a) 20 to 60% by weight of at least one isoalkenyl oligoglucoside, (b) 40 to 80% by weight of at least one isoalkenyl fatty alcohol and (c) 0 to 10% by weight of water.

Isoalkenyl Fatty Alcohols

The fatty alcohols are branched unsaturated fatty alcohols which have a liquid consistency above 10° C. These are preferably C₁₀₋₅₄ isoalkenyl alcohols, more preferably C₁₀₋₃₀ isoalkenyl alcohols and most preferably C₁₆₋₂₂ isoalkenyl alcohols which may be of natural or synthetic origin. At least one branch point is present in the alkenyl chain and may even be statistically distributed through the synthesis method. Preferably, no more than three, preferably unconjugated double bonds are present in the alkyl chain. According to the invention, the preferred fatty alcohol component is iso-oleyl alcohol, more particularly methyl-branched oleyl alcohol, i.e. a methyl heptadecene. This iso-oleyl alcohol is obtained by hydrogenation of the so-called monomer fatty acid or monomer fatty acid methyl ester which is formed as a secondary product in the dimerization of oleic acid/linoleic acid mixtures. According to the invention, mixtures of branched, unsaturated fatty alcohols, for example isoerucyl alcohol or isobrassidyl alcohol or mixtures thereof or even mixtures of these two C₂₂ alcohols with iso-oleyl alcohol, may also be used as the isoalkenyl component.

Isoalkenyl Oligoglycosides

The emulsifier concentrate preferably contains isoalkenyl oligoglycosides corresponding to formula (I):
R¹O-[G]ₚ (I)
in which R₁ is an isoalkenyl group containing 10 to 54 carbon atoms, G is a sugar unit containing 5 or 6 carbon atoms and p is a number of 1 to 10. R¹ is preferably an isoalkenyl group containing 10 to 30 carbon atoms and, more particularly, 16 to 22 carbon atoms. At least one branch point is present in the alkenyl chain and may even be statistically distributed through the synthesis method. Preferably, no more than three, preferably unconjugated double bonds are present in the alkenyl chain.

These sugar surfactants may be obtained by the relevant methods of preparative organic chemistry. EP 0 301 298 A1 and WO 90/03977 are cited as representative of the extensive literature available on the subject.

The isoalkenyl oligoglycosides may be derived from aldoses or ketoses containing 5 or 6 carbon atoms, for example glucose, dextrose, sucrose, fructose, galactose, latose, maltotriose, lactose, cellobiose, mannose, ribose, talose, allose, xylose, lyxose, gulose, idose, arabinose, and from dextrans, levoglucosans and cellulose. According to the invention, glucose is preferred so that the preferred iso-alkenyl oligoglycosides are iso-alkenyl oligoglucosides.

The index p in general formula (I) indicates the degree of oligomerization (DP), i.e. the distribution of mono- and oligoglycosides, and is a number of 1 to 10. Whereas p in a given compound must always be an integer and, above all, may assume a value of 1 to 6, the value p for a certain alkyl oligoglycoside is an analytically determined calculated quantity which is generally a broken number. Isoalkenyl oligoglycosides having an average degree of oligomerization p of 1.1 to 3.0 are preferably used. Isoalkenyl oligoglycosides having a degree of oligomerization of less than 1.7 and, more particularly, between 1.2 and 1.4 are preferred from the applicational perspective.

A preferred embodiment of the concentrate contains (a) 0.5 to 90% by weight of at least one iso-oleyl oligoglucoside, (b) 0.5 to 90% by weight of at least one iso-oleyl alcohol and (c) 0 to 10% by weight of water. Particularly preferred concentrates contain (a) 15 to 80% by weight of at least one iso-oleyl oligoglucoside, (b) 20 to 85% by weight of at least one iso-oleyl alcohol and (c) 0 to 10% by weight of water. Most particularly preferred concentrates contain (a) 20 to 60% by weight of at least one iso-oleyl oligoglucoside, (b) 40 to 80% by weight of at least one iso-oleyl alcohol and (c) 0 to 10% by weight of water. Such concentrates are liquid, even at 5° C., show a particularly advantageous combination of lipid-layer-enhancing and emulsifying properties and are easy to incorporate without heating for the production of creams, lotions and shampoos.

Production Process

The present invention also relates to a process for the production of the emulsifier concentrates according to the invention in which a sugar (ose) and excess isoalkenyl fatty alcohol are subjected to acidic acetalization,
(a) the educt ratio of sugar to isoalkenyl fatty alcohol being adjusted so that the required ratio of isoalkenyl oligoglycoside to isoalkenyl fatty alcohol is directly achieved after the synthesis
   or, in the resulting mixture of isoalkenyl oligoglycosides and excess isoalkenyl fatty alcohol,
(b) the isoalkenyl fatty alcohol content of the mixture being reduced to the required level either by distilling off the fatty alcohol or by addition of more isoalkenyl oligoglycoside or
(c) the isoalkenyl fatty alcohol content of the mixture being increased to the required level by subsequent addition of isoalkenyl fatty alcohol.

This process enables cosmetically acceptable and dermatologically particularly safe products of very good color and odor quality to be obtained because the products do not polymerize to the same extent under acid catalysis as the unsaturated unbranched analogs and are far more stable to oxidation.

However, the starting materials are preferably the technical isoalkenyl oligoglycoside/isoalkenyl fatty alcohol mixtures which are formed in the production of isoalkenyl oligoglycosides by acid-catalyzed acetalization of oses with the corresponding fatty alcohols in excess. These mixtures typically contain ca. 60 to 85% by weight isoalkenyl fatty alcohol and 15 to 40% by weight of the isoalkenyl oligoglycosides.

Basically, a higher isoalkenyl oligoglycoside content may be adjusted by two methods: either the isoalkenyl fatty alcohol content is reduced to the required level by subsequent distillation in a thin-layer or falling-film evaporator or the isoalkenyl oligoglycoside content is increased by preferably water-free isoalkenyl oligoglycosides which, in turn, can be obtained from water-containing pastes by drying with superheated steam or by the removal of water in a flash dryer. Concentrates with a higher isoalkenyl oligoglycoside content show good lipid-layer-enhancing and, at the same time, good emulsifying properties.

A higher isoalkenyl fatty alcohol content is adjusted by subsequent addition of isoalkenyl fatty alcohol. Where the emulsifier concentrates have a higher fatty alcohol content, the lipid-layer-enhancing properties are paramount.

In a preferred embodiment of the invention, glucose and iso-oleyl alcohol are acetalized in known manner and excess iso-oleyl alcohol is partly removed, so that the products obtained contain more than 30% by weight isoalkenyl glucoside. If necessary, polyglucose formed can be removed with the aid of membranes.

In another preferred process for the production of the emulsifier concentrates according to the invention, glucose or starch syrup, for example, is first reacted with a short-chain alcohol, for example butanol, or a head-fractionated fatty alcohol to form a lower alkyl glucoside which is then transacetalized with the required long-chain isoalkenyl fatty alcohol, preferably oleyl alcohol. Further working up may then be carried out as described above.

Hydrophilic Waxes

In a preferred embodiment of the invention, the emulsifier concentrates additionally contain a thickening hydrophilic wax which is selected from substances that are solid at room temperature and contain free hydroxyl groups. Typical examples are fatty acid partial glycerides, i.e. technical mono- and/or diesters of glycerol with C₁₂₋₁₈ fatty acids, such as for example glycerol mono/dilaurate, palmitate, oleate or stearate. Fatty alcohols, such as for example technical C₁₂₋₂₂ fatty alcohols, namely cetyl alcohol, stearyl alcohol or cetearyl alcohol, are also suitable. The hydrophilic waxes are only present in such quantities that the consistency of the mixture still remains liquid. Corresponding optimizations are routine to the expert.

Advantageous mixtures of emulsifier components (a), (b), (c) and hydrophilic waxes (c) contain, for example,
(a) 10 to 65% by weight isoalkenyl oligoglycosides,
(b) 10 to 65% isoalkenyl fatty alcohols,
(c) 0 to 10% by weight water and
(c) 0.1 to 30% by weight hydrophilic waxes such as, for example, fatty acid partial glycerides.

The addition of the hydrophilic waxes enables the lipid-layer-enhancing properties to be further improved and even stronger thickening properties to be imparted to the concentrates according to the invention which, nevertheless, are easy to incorporate and remain stable in storage.

Cosmetic/Pharmaceutical Preparations

The emulsifiers according to the invention enables stable emulsions and surfactant formulations to be produced by processes involving no heating. In contrast to known emulsifier concentrates based on saturated and unbranched fatty alcohols, they show far better lipid-layer-enhancing properties for comparable emulsifying capacity which is relevant to a large number of cosmetic application forms. The concentrates according to the invention also show better emulsifying capacity, i.e. smaller quantities of the concentrate can be used, so that the resulting compositions are more compatible with the skin. Accordingly, the present invention relates to cosmetic or pharmaceutical preparations containing 0.1 to 30% by weight of the emulsifier concentrates. The preparations in question are preferably surfactant-containing formulations which are expected to combine good foaming behavior with good lipid-layer-enhancing properties and high dermatological compatibility, for example shower gels and oils, foam baths, hair shampoos, hair rinses, etc. However, the emulsifier concentrates may also be used for the formulation of body-care products, such as for example creams, lotions and milks, products for eliminating body odor and the like. The cosmetic formulations contain a number of other auxiliaries and additives according to the application envisaged, including for example surfactants, oil components, emulsifiers, pearlizing waxes, consistency factors, thickeners, superfatting agents, stabilizers, polymers, silicone compounds, fats, waxes, lecithins, phospholipids, biogenic agents, antioxidants, UV protection factors, antioxidants, deodorants, antiperspirants, antidandruff agents, film formers, swelling agents, insect repellents, self-tanning agents, tyrosine inhibitors (depigmenting agents), hydrotropes, solubilizers, preservatives, perfume oils, dyes and the like which are listed by way of example in the following.

Surfactants

The surfactants present may be anionic, nonionic, cationic and/or amphoteric or zwitterionic surfactants. A preferred embodiment of the cosmetic preparation according to the invention additionally contains at least one surfactant, preferably an anionic surfactant. The lipid-layer-enhancing effect of the emulsifier combination according to the invention is particularly advantageous in surfactant-containing cosmetic preparations, such as for example shower gels, foam baths, shampoos, etc. The percentage content of the additional surfactants is typically ca. 1 to 30% by weight, preferably 5 to 25% by weight and more particularly 10 to 20% by weight.

Typical examples of anionic surfactants are soaps, alkyl benzenesulfonates, alkanesulfonates, olefin sulfonates, alkylether sulfonates, glycerol ether sulfonates, α-methyl ester sulfonates, sulfofatty acids, alkyl sulfates, fatty alcohol ether sulfates, glycerol ether sulfates, fatty acid ether sulfates, hydroxy mixed ether sulfates, monoglyceride (ether) sulfates, fatty acid amide (ether) sulfates, mono- and dialkyl sulfosuccinates, mono- and dialkyl sulfosuccinamates, sulfotriglycerides, amide soaps, ether carboxylic acids and salts thereof, fatty acid isethionates, fatty acid sarcosinates, fatty acid taurides, N-acylamino acids such as, for example, acyl lactylates, acyl tartrates, acyl glutamates and acyl aspartates, alkyl oligoglucoside sulfates, fatty alcohol ether carboxylates, protein fatty acid condensates (particularly wheat-based vegetable products) and alkyl (ether) phosphates. If the anionic surfactants contain polyglycol ether chains, they may have a conventional homolog distribution although they preferably have a narrow-range homolog distribution. Typical examples of nonionic surfactants are fatty alcohol polyglycol ethers, alkylphenol polyglycol ethers, fatty acid polyglycol esters, fatty acid amide polyglycol ethers, fatty amine polyglycol ethers, alkoxylated triglycerides, mixed ethers and mixed formals, optionally partly oxidized alk(en)yl oligoglycosides or glucuronic acid derivatives, fatty acid-N-alkyl glucamides, protein hydrolyzates (particularly wheat-based vegetable products), polyol fatty acid esters, sugar esters, sorbitan esters, polysorbates and amine oxides. If the nonionic surfactants contain polyglycol ether chains, they may have a conventional homolog distribution, although they preferably have a narrow-range homolog distribution. Typical examples of cationic surfactants are quaternary ammonium compounds, for example dimethyl distearyl ammonium chloride, and esterquats, more particularly quaternized fatty acid trialkanolamine ester salts. Typical examples of amphoteric or zwitterionic surfactants are alkylbetaines, alkylamidobetaines, aminopropionates, aminoglycinates, imidazolinium betaines and sulfobetaines. The surfactants mentioned are all known compounds. Information on their structure and production can be found in relevant synoptic works in this field. Typical examples of particularly suitable mild, i.e. particularly dermatologically compatible, surfactants are fatty alcohol polyglycol ether sulfates, monoglyceride sulfates, mono- and/or dialkyl sulfosuccinates, fatty acid isethionates, fatty acid sarcosinates, fatty acid taurides, fatty acid glutamates, α-olefin sulfonates, ether carboxylic acids, alkyl oligoglucosides, fatty acid glucamides, alkylamidobetaines, amphoacetals and/or protein fatty acid condensates, preferably based on wheat proteins.

A particularly preferred anionic surfactant is fatty alcohol ether sulfate.

Oil Components

Body care preparations, such as creams, lotions and milks, which contain the emulsifier concentrate according to the invention, contain oil components. The oil components are normally present in a quantity of 1 to 50% by weight, preferably 2 to 25% by weight and more particularly 2 to 15% by weight. Suitable oil components are, for example, Guerbet alcohols based on fatty alcohols containing 6 to 18 and preferably 8 to 10 carbon atoms, esters of linear C₆₋₂₂ fatty acids with linear or branched C₆₋₂₂ fatty alcohols or esters of branched C₆₋₁₃ carboxylic acids with linear or branched C₆₋₂₂ fatty alcohols such as, for example, myristyl myristate, myristyl palmitate, myristyl stearate, myristyl isostearate, myristyl oleate, myristyl behenate, myristyl erucate, cetyl myristate, cetyl palmitate, cetyl stearate, cetyl isostearate, cetyl oleate, cetyl behenate, cetyl erucate, stearyl myristate, stearyl palmitate, stearyl stearate, stearyl isostearate, stearyl oleate, stearyl behenate, stearyl erucate, isostearyl myristate, isostearyl palmitate, isostearyl stearate, isostearyl isostearate, isostearyl oleate, isostearyl behenate, isostearyl oleate, oleyl myristate, oleyl palmitate, oleyl stearate, oleyl isostearate, oleyl oleate, oleyl behenate, oleyl erucate, behenyl myristate, behenyl palmitate, behenyl stearate, behenyl isostearate, behenyl oleate, behenyl behenate, behenyl erucate, erucyl myristate, erucyl palmitate, erucyl stearate, erucyl isostearate, erucyl oleate, erucyl behenate and erucyl erucate. Also suitable are esters of linear C₆₋₂₂ fatty acids with branched alcohols, more particularly 2-ethyl hexanol, esters of C₁₈₋₃₈ alkylhydroxycarboxylic acids with linear or branched C₆₋₂₂ fatty alcohols, more especially Dioctyl Malate, esters of linear and/or branched fatty acids with polyhydric alcohols (for example propylene glycol, dimer diol or trimer triol) and/or Guerbet alcohols, triglycerides based on C₆₋₁₀ fatty acids, liquid mono-, di- and triglyceride mixtures based on C₆₋₁₈ fatty acids, esters of C₆₋₂₂ fatty alcohols and/or Guerbet alcohols with aromatic carboxylic acids, more particularly benzoic acid, esters of C₂₋₁₂ dicarboxylic acids with linear or branched alcohols containing 1 to 22 carbon atoms or polyols containing 2 to 10 carbon atoms and 2 to 6 hydroxyl groups, vegetable oils, branched primary alcohols, substituted cyclohexanes, linear and branched C₆₋₂₂ fatty alcohol carbonates, such as Dicaprylyl Carbonate (Cetiol® CC) for example, Guerbet carbonates based on C₆₋₁₈ and preferably C₈₋₁₀ fatty alcohols, esters of benzoic acid with linear and/or branched C₆₋₂₂ alcohols (for example Finsolv® TN), linear or branched, symmetrical or nonsymmetrical dialkyl ethers containing 6 to 22 carbon atoms per alkyl group, such as Dicaprylyl Ether (Cetiol® OE) for example, ring opening products of epoxidized fatty acid esters with polyols, silicone oils (cyclomethicone, silicon methicone types, etc.) and/or aliphatic or naphthenic hydrocarbons such as, for example, squalane, squalene or dialkyl cyclohexanes.

Emulsifiers

Suitable additional emulsifiers are, for example, nonionic surfactants from at least one of the following groups:
products of the addition of 2 to 30 mol ethylene oxide and/or 0 to 5 mol propylene oxide onto linear C₈₋₂₂ fatty alcohols, onto C₁₂₋₂₂ fatty acids, onto alkyl phenols containing 8 to 15 carbon atoms in the alkyl group and onto alkylamines containing 8 to 22 carbon atoms in the alkyl group;
alkyl oligoglycosides containing 8 to 22 carbon atoms in the alkyl group and ethoxylated analogs thereof;
addition products of 1 to 15 mol ethylene oxide onto castor oil and/or hydrogenated castor oil;
addition products of 15 to 60 mol ethylene oxide onto castor oil and/or hydrogenated castor oil;
partial esters of glycerol and/or sorbitan with unsaturated, linear or saturated, branched fatty acids containing 12 to 22 carbon atoms and/or hydroxycarboxylic acids containing 3 to 18 carbon atoms and addition products thereof onto 1 to 30 mol ethylene oxide;
partial esters of polyglycerol (average degree of self-condensation 2 to 8), polyethylene glycol (molecular weight 400 to 5,000), trimethylolpropane, pentaerythritol, sugar alcohols (for example sorbitol), alkyl glucosides (for example methyl glucoside, butyl glucoside, lauryl glucoside) and polyglucosides (for example cellulose) with saturated and/or unsaturated, linear or branched fatty acids containing 12 to 22 carbon atoms and/or hydroxycarboxylic acids containing 3 to 18 carbon atoms and addition products thereof onto 1 to 30 mol ethylene oxide;
mixed esters of pentaerythritol, fatty acids, citric acid and fatty alcohol and/or mixed esters of fatty acids containing 6 to 22 carbon atoms, methyl glucose and polyols, preferably glycerol or polyglycerol,
mono-, di- and trialkyl phosphates and mono-, di- and/or tri-PEG-alkyl phosphates and salts thereof,
wool wax alcohols,
polysiloxane/polyalkyl/polyether copolymers and corresponding derivatives,
block copolymers, for example Polyethyleneglycol-30 Dipolyhydroxystearate;
polymer emulsifiers, for example Pemulen types (TR-1, TR-2) of Goodrich;
polyalkylene glycols and
glycerol carbonate.

Ethylene Oxide Addition Products
The addition products of ethylene oxide and/or propylene oxide onto fatty alcohols, fatty acids, alkylphenols or onto castor oil are known commercially available products. They are homolog mixtures of which the average degree of alkoxylation corresponds to the ratio between the quantities of ethylene oxide and/or propylene oxide and substrate with which the addition reaction is carried out. C_{12/18} fatty acid monoesters and diesters of addition products of ethylene oxide onto glycerol are known as refatting agents for cosmetic formulations.

Sorbitan Esters
Suitable sorbitan esters are sorbitan monoisostearate, sorbitan sesquiisostearate, sorbitan diisostearate, sorbitan triisostearate, sorbitan monooleate, sorbitan sesquioleate, sorbitan dioleate, sorbitan trioleate, sorbitan monoerucate, sorbitan sesquierucate, sorbitan dierucate, sorbitan trierucate, sorbitan monoricinoleate, sorbitan sesquiricinoleate, sorbitan diricinoleate, sorbitan triricinoleate, sorbitan monohydroxystearate, sorbitan sesquihydroxystearate, sorbitan dihydroxystearate, sorbitan trihydroxystearate, sorbitan monotartrate, sorbitan sesquitartrate, sorbitan ditartrate, sorbitan tritartrate, sorbitan monocitrate, sorbitan sesquicitrate, sorbitan dicitrate, sorbitan tricitrate, sorbitan monomaleate, sorbitan sesquimaleate, sorbitan dimaleate, sorbitan trimaleate and technical mixtures thereof. Addition products of 1 to 30 and preferably 5 to 10 mol ethylene oxide onto the sorbitan esters mentioned are also suitable.

Polyglycerol Esters
Typical examples of suitable polyglycerol esters are Polyglyceryl-2 Dipolyhydroxystearate (Dehymuls® PGPH), Polyglycerin-3-Diisostearate (Lameform® TGI), Polyglyceryl-4 Isostearate (Isolan® GI 34), Polyglyceryl-3 Oleate, Diisostearoyl Polyglyceryl-3 Diisostearate (Isolan® PDI), Polyglyceryl-3 Methylglucose Distearate (Tego Care® 450), Polyglyceryl-3 Beeswax (Cera Bellina®), Polyglyceryl-4 Caprate (Polyglycerol Caprate T2010/90), Polyglyceryl-3 Cetyl Ether (Chimexane®) NL), Polyglyceryl-3 Distearate (Cremophor® GS 32) and Polyglyceryl Polyricinoleate (Admul® WOL 1403), Polyglyceryl Dimerate Isostearate and mixtures thereof. Examples of other suitable polyolesters are the mono-, di- and triesters of trimethylolpropane or pentaerythritol with lauric acid, cocofatty acid, tallow fatty acid, palmitic acid, stearic acid, oleic acid, behenic acid and the like optionally reacted with 1 to 30 mol ethylene oxide.

Anionic Emulsifiers
Typical anionic emulsifiers are aliphatic fatty acids containing 12 to 22 carbon atoms such as, for example, palmitic acid, stearic acid or behenic acid and dicarboxylic acids containing 12 to 22 carbon atoms such as, for example, azelaic acid or sebacic acid.

Amphoteric and Cationic Emulsifiers
Other suitable emulsifiers are zwitterionic surfactants. Zwitterionic surfactants are surface-active compounds which contain at least one quaternary ammonium group and at least one carboxylate and one sulfonate group in the molecule. Particularly suitable zwitterionic surfactants are the so-called betaines, such as the N-alkyl-N,N-dimethyl ammonium glycinates, for example cocoalkyl dimethyl ammonium glycinate, N-acylaminopropyl-N,N-dimethyl ammonium glycinates, for example cocoacylaminopropyl dimethyl ammonium glycinate, and 2-alkyl-3-carboxymethyl-3-hydroxyethyl imidazolines containing 8 to 18 carbon atoms in the alkyl or acyl group and cocoacylaminoethyl hydroxyethyl carboxymethyl glycinate. The fatty acid amide derivative known under the CTFA name of Cocamidopropyl Betaine is particularly preferred. Ampholytic surfactants are also suitable emulsifiers. Ampholytic surfactants are surface-active compounds which, in addition to a C_{8/18} alkyl or acyl group, contain at least one free amino group and at least one —COOH— or —SO₃H— group in the molecule and which are capable of forming inner salts. Examples of suitable ampholytic surfactants are N-alkyl glycines, N-alkyl propionic acids, N-alkylaminobutyric acids, N-alkyliminodipropionic acids, N-hydroxyethyl-N-alkylamidopropyl glycines, N-alkyl taurines, N-alkyl sarcosines, 2-alkylaminopropionic acids and alkylaminoacetic acids containing around 8 to 18 carbon atoms in the alkyl group. Particularly preferred ampholytic surfactants are N-coco-alkylaminopropionate, cocoacylaminoethyl aminopropionate and C_{12/18} acyl sarcosine. Finally, cationic surfactants are also suitable emulsifiers, those of the esterquat type, preferably methyl-quaternized difatty acid triethanolamine ester salts, being particularly preferred.
   Fats and Waxes

Fats and waxes are added to the body care products. Typical examples of fats are glycerides, i.e. solid or liquid, vegetable or animal products which consist essentially of mixed glycerol esters of higher fatty acids. Suitable waxes are inter alia natural waxes such as, for example, candelilla wax, carnauba wax, Japan wax, espartograss wax, cork wax, guaruma wax, rice oil wax, sugar cane wax, ouricury wax, montan wax, beeswax, shellac wax, spermaceti, lanolin (wool wax), uropygial fat, ceresine, ozocerite (earth wax), petrolatum, paraffin waxes and microwaxes; chemically modified waxes (hard waxes) such as, for example, montan ester waxes, sasol waxes, hydrogenated jojoba waxes and synthetic waxes such as, for example, polyalkylene waxes and polyethylene glycol waxes. Besides the fats, other suitable additives are fat-like substances, such as lecithins and phospholipids. Lecithins are known among experts as glycerophospholipids which are formed from fatty acids, glycerol, phosphoric acid and choline by esterification. Accordingly, lecithins are also frequently referred to by experts as phosphatidyl cholines (PCs). Examples of natural lecithins are the kephalins which are also known as phosphatidic acids and which are derivatives of 1,2-diacyl-sn-glycerol-3-phosphoric acids. By contrast, phospholipids are generally understood to be mono- and preferably diesters of phosphoric acid with glycerol (glycerophosphates) which are normally classed as fats. Sphingosines and sphingolipids are also suitable.

Pearlizing Waxes

Suitable pearlizing waxes are, for example, alkylene glycol esters, especially ethylene glycol distearate; fatty acid alkanolamides, especially cocofatty acid diethanolamide; partial glycerides, especially stearic acid monoglyceride; esters of polybasic, optionally hydroxysubstituted carboxylic acids with fatty alcohols containing 6 to 22 carbon atoms, especially long-chain esters of tartaric acid; fatty compounds, such as for example fatty alcohols, fatty ketones, fatty aldehydes, fatty ethers and fatty carbonates which contain in all at least 24 carbon atoms, especially laurone and distearylether; fatty acids, such as stearic acid, hydroxystearic acid or behenic acid, ring opening products of olefin epoxides containing 12 to 22 carbon atoms with fatty alcohols containing 12 to 22 carbon atoms and/or polyols containing 2 to 15 carbon atoms and 2 to 10 hydroxyl groups and mixtures thereof.

Consistency Factors and Thickeners

The consistency factors mainly used are fatty alcohols or hydroxyfatty alcohols containing 12 to 22 and preferably 16 to 18 carbon atoms and also partial glycerides, fatty acids or hydroxyfatty acids. A combination of these substances with alkyl oligoglucosides and/or fatty acid N-methyl glucamides of the same chain length and/or polyglycerol poly-12-hydroxystearates is preferably used. Suitable thickeners are, for example, Aerosil® types (hydrophilic silicas), polysaccharides, more especially xanthan gum, guar-guar, agar-agar, alginates and tyloses, carboxymethyl cellulose and hydroxyethyl and hydroxypropyl cellulose, also relatively high molecular weight polyethylene glycol monoesters and diesters of fatty acids, polyacrylates (for example Carbopols® and Pemulen types [Goodrich]; Synthalens® [Sigma]; Keltrol types [Kelco]; Sepigel types [Seppic]; Salcare types [Allied Colloids]), polyacrylamides, polymers, polyvinyl alcohol and polyvinyl pyrrolidone. Other consistency factors which have proved to be particularly effective are bentonites, for example Bentone® Gel VS-5PC (Rheox) which is a mixture of cyclopentasiloxane, Disteardimonium Hectorite and propylene carbonate. Other suitable consistency factors are surfactants such as, for example, ethoxylated fatty acid glycerides, esters of fatty acids with polyols, for example pentaerythritol or trimethylol propane, narrow-range fatty alcohol ethoxylates or alkyl oligoglucosides and electrolytes, such as sodium chloride and ammonium chloride.

Superfatting Agents

Superfatting agents may be selected from such substances as, for example, lanolin and lecithin and also polyethoxylated or acylated lanolin and lecithin derivatives, polyol fatty acid esters, monoglycerides and fatty acid alkanolamides, the fatty acid alkanolamides also serving as foam stabilizers.

Stabilizers

Metal salts of fatty acids such as, for example, magnesium, aluminium and/or zinc stearate or ricinoleate may be used as stabilizers.

Polymers

Suitable cationic polymers are, for example, cationic cellulose derivatives such as, for example, the quaternized hydroxyethyl cellulose obtainable from Amerchol under the name of Polymer JR 400®, cationic starch, copolymers of diallyl ammonium salts and acrylamides, quaternized vinyl pyrrolidone/vinyl imidazole polymers such as, for example, Luviquat® (BASF), condensation products of polyglycols and amines, quaternized collagen polypeptides such as, for example, Lauryidimonium Hydroxypropyl Hydrolyzed Collagen (Lamequat® L, Grünau), quaternized wheat polypeptides, polyethyleneimine, cationic silicone polymers such as, for example, amodimethicone, copolymers of adipic acid and dimethylaminohydroxypropyl diethylenetriamine (Cartaretine®, Sandoz), copolymers of acrylic acid with dimethyl diallyl ammonium chloride (Merquat® 550, Chemviron), polyaminopolyamides and crosslinked water-soluble polymers thereof, cationic chitin derivatives such as, for example, quaternized chitosan, optionally in microcrystalline distribution, condensation products of dihaloalkyls, for example dibromobutane, with bis-dialkylamines, for example bis-dimethylamino-1,3-propane, cationic guar gum such as, for example, Jaguar®CBS, Jaguar®-17, Jaguar®-16 of Celanese, quaternized ammonium salt polymers such as, for example, Mirapol® A-15, Mirapol® AD-1, Mirapol® AZ-1 of Miranol.

Suitable anionic, zwitterionic, amphoteric and nonionic polymers are, for example, vinyl acetate/crotonic acid copolymers, vinyl pyrrolidone/vinyl acrylate copolymers, vinyl acetate/butyl maleate/isobornyl acrylate copolymers, methyl vinylether/maleic anhydride copolymers and esters thereof, uncrosslinked and polyol-crosslinked polyacrylic acids, acrylamidopropyl trimethylammonium chloride/acrylate copolymers, octylacrylamide/methyl methacrylate/tert.-butylaminoethyl methacrylate/2-hydroxypropyl methacrylate copolymers, polyvinyl pyrrolidone, vinyl pyrrolidone/vinyl acetate copolymers, vinyl pyrrolidone/dimethylaminoethyl methacrylate/vinyl caprolactam terpolymers and optionally derivatized cellulose ethers and silicones.

Silicone Compounds

Suitable silicone compounds are, for example, dimethyl polysiloxanes, methylphenyl polysiloxanes, cyclic silicones and amino-, fatty acid-, alcohol-, polyether-, epoxy-, fluorine-, glycoside- and/or alkyl-modified silicone compounds which may be both liquid and resin-like at room temperature. Other suitable silicone compounds are simethicones which are mixtures of dimethicones with an average chain length of 200 to 300 dimethylsiloxane units and hydrogenated silicates.

UV Protection Factors and Antioxidants

UV protection factors in the context of the invention are, for example, organic substances (light filters) which are liquid or crystalline at room temperature and which are capable of absorbing ultraviolet radiation and of releasing the energy absorbed in the form of longer-wave radiation, for example heat. UV-B filters can be oil-soluble or water-soluble. The following are examples of oil-soluble substances:
3-benzylidene camphor or 3-benzylidene norcamphor and derivatives thereof, for example 3-(4-methylbenzylidene)-camphor;
4-aminobenzoic acid derivatives, preferably 4-(dimethylamino)-benzoic acid-2-ethylhexyl ester, 4-(dimethylamino)-benzoic acid-2-octyl ester and 4-(dimethylamino)-benzoic acid amyl ester;
esters of cinnamic acid, preferably 4-methoxycinnamic acid-2-ethylhexyl ester, 4-methoxycinnamic acid propyl ester, 4-methoxycinnamic acid isoamyl ester, 2-cyano-3,3-phenylcinnamic acid-2-ethylhexyl ester (Octocrylene);
esters of salicylic acid, preferably salicylic acid-2-ethylhexyl ester, salicylic acid-4-isopropylbenzyl ester, salicylic acid homomenthyl ester;
derivatives of benzophenone, preferably 2-hydroxy-4-methoxybenzophenone, 2-hydroxy-4-methoxy-4′-methylbenzophenone, 2,2′-dihydroxy-4-methoxybenzophenone;
esters of benzalmalonic acid, preferably 4-methoxybenzalmalonic acid di-2-ethylhexyl ester;
triazine derivatives such as, for example, 2,4,6-trianilino-(p-carbo-2′-ethyl-1′-hexyloxy)-1,3,5-triazine and Octyl Triazone or Dioctyl Butamido Triazone (Uvasorb® HEB);
propane-1,3-diones such as, for example, 1-(4-tert.butylphenyl)-3-(4′-methoxyphenyl)-propane-1,3-dione;
ketotricyclo(5.2.1.0)decane derivatives.

Suitable water-soluble substances are
2-phenylbenzimidazole-5-sulfonic acid and alkali metal, alkaline earth metal, ammonium, alkylammonium, alkanolammonium and glucammonium salts thereof;
sulfonic acid derivatives of benzophenones, preferably 2-hydroxy-4-methoxybenzophenone-5-sulfonic acid and salts thereof;
sulfonic acid derivatives of 3-benzylidene camphor such as, for example, 4-(2-oxo-3-bornylidenemethyl)-benzene sulfonic acid and 2-methyl-5-(2-oxo-3-bornylidene)-sulfonic acid and salts thereof.

Typical UV-A filters are, in particular, derivatives of benzoyl methane such as, for example, 1-(4′-tert.butylphenyl)-3-(4′-methoxyphenyl)-propane-1,3-dione, 4-tert.butyl-4′-methoxydibenzoyl methane (Parsol® 1789) or 1-phenyl-3-(4′-isopropylphenyl)-propane-1,3-dione and enamine compounds. The UV-A and UV-B filters may of course also be used in the form of mixtures. Particularly favorable combinations consist of the derivatives of benzoyl methane, for example 4-tert.butyl-4′-methoxydibenzoylmethane (Parsol® 1789) and 2-cyano-3,3-phenylcinnamic acid-2-ethyl hexyl ester (Octocrylene) in combination with esters of cinnamic acid, preferably 4-methoxycinnamic acid-2-ethyl hexyl ester and/or 4-methoxycinnamic acid propyl ester and/or 4-methoxycinnamic acid isoamyl ester. Combinations such as these are advantageously combined with water-soluble filters such as, for example, 2-phenylbenzimidazole-5-sulfonic acid and alkali metal, alkaline earth metal, ammonium, alkylammonium, alkanolammonium and glucammonium salts thereof.

Besides the soluble substances mentioned, insoluble light-blocking pigments, i.e. finely dispersed metal oxides or salts, may also be used for this purpose. Examples of suitable metal oxides are, in particular, zinc oxide and titanium dioxide and also oxides of iron, zirconium oxide, silicon, manganese, aluminium and cerium and mixtures thereof. Silicates (talcum), barium sulfate and zinc stearate may be used as salts. The oxides and salts are used in the form of the pigments for skin-care and skin-protecting emulsions and decorative cosmetics. The particles should have a mean diameter of less than 100 nm, preferably between 5 and 50 nm and more preferably between 15 and 30 nm. They may be spherical in shape although ellipsoidal particles or other non-spherical particles may also be used. The pigments may also be surface-treated, i.e. hydrophilicized or hydrophobicized. Typical examples are coated titanium dioxides, for example Titandioxid T 805 (Degussa) and Eusolex® T2000 (Merck). Suitable hydrophobic coating materials are, above all, silicones and, among these, especially trialkoxyoctylsilanes or simethicones. So-called micro- or nanopigments are preferably used in sun protection products. Micronized zinc oxide is preferably used.

Besides the two groups of primary sun protection factors mentioned above, secondary sun protection factors of the antioxidant type may also be used. Secondary sun protection factors of the antioxidant type interrupt the photochemical reaction chain which is initiated when UV rays penetrate into the skin. Typical examples are amino acids (for example glycine, histidine, tyrosine, tryptophane) and derivatives thereof, imidazoles (for example urocanic acid) and derivatives thereof, peptides, such as D,L-carnosine, D-carnosine, L-carnosine and derivatives thereof (for example anserine), carotinoids, carotenes (for example α-carotene, β-carotene, lycopene) and derivatives thereof, chlorogenic acid and derivatives thereof, liponic acid and derivatives thereof (for example dihydroliponic acid), aurothioglucose, propylthiouracil and other thiols (for example thioredoxine, glutathione, cysteine, cystine, cystamine and glycosyl, N-acetyl, methyl, ethyl, propyl, amyl, butyl and lauryl, palmitoyl, oleyl, γ-linoleyl, cholesteryl and glyceryl esters thereof) and their salts, dilaurylthiodipropionate, distearylthiodipropionate, thiodipropionic acid and derivatives thereof (esters, ethers, peptides, lipids, nucleotides, nucleosides and salts) and sulfoximine compounds (for example butionine sulfoximines, homocysteine sulfoximine, butionine sulfones, penta-, hexa- and hepta-thionine sulfoximine) in very small compatible dosages (for example pmol to μmol/kg), also (metal) chelators (for example α-hydroxyfatty acids, palmitic acid, phytic acid, lactoferrine), α-hydroxy acids (for example citric acid, lactic acid, malic acid), humic acid, bile acid, bile extracts, bilirubin, biliverdin, EDTA, EGTA and derivatives thereof, unsaturated fatty acids and derivatives thereof (for example γ-linolenic acid, linoleic acid, oleic acid), folic acid and derivatives thereof, ubiquinone and ubiquinol and derivatives thereof, vitamin C and derivatives thereof (for example ascorbyl palmitate, Mg ascorbyl phosphate, ascorbyl acetate), tocopherols and derivatives (for example vitamin E acetate), vitamin A and derivatives (vitamin A palmitate) and coniferyl benzoate of benzoin resin, rutinic acid and derivatives thereof, α-glycosyl rutin, ferulic acid, furfurylidene glucitol, carnosine, butyl hydroxytoluene, butyl hydroxyanisole, nordihydroguaiac resin acid, nordihydroguaiaretic acid, trihydroxybutyrophenone, uric acid and derivatives thereof, mannose and derivatives thereof, superoxide dismutase, zinc and derivatives thereof (for example ZnO, ZnSO₄), selenium and derivatives thereof (for example selenium methionine), stilbenes and derivatives thereof (for example stilbene oxide, trans-stilbene oxide) and derivatives of these active substances suitable for the purposes of the invention (salts, esters, ethers, sugars, nucleotides, nucleosides, peptides and lipids).

Biogenic Agents

In the context of the invention, biogenic agents are, for example, tocopherol, tocopherol acetate, tocopherol palmitate, ascorbic acid, (deoxy)ribonucleic acid and fragmentation products thereof, β-glucans, retinol, bisabolol, allantoin, phytantriol, panthenol, AHA acids, amino acids, ceramides, pseudoceramides, essential oils, plant extracts, for example prunus extract, bambara nut extract, and vitamin complexes.

Deodorants and Germ Inhibitors

Cosmetic deodorants counteract, mask or eliminate body odors. Body odors are formed through the action of skin bacteria on apocrine perspiration which results in the formation of unpleasant-smelling degradation products. Accordingly, deodorants contain active principles which act as germ inhibitors, enzyme inhibitors, odor absorbers or odor maskers.

Germ Inhibitors
Basically, suitable germ inhibitors are any substances which act against gram-positive bacteria such as, for example, 4-hydroxybenzoic acid and salts and esters thereof, N-(4-chlorophenyl)-N′-(3,4-dichlorophenyl)-urea, 2,4,4′-trichloro-2′-hydroxydiphenylether (triclosan), 4-chloro-3,5-dimethylphenol, 2,2′-methylene-bis-(6-bromo-4-chlorophenol), 3-methyl4-(1-methylethyl)-phenol, 2-benzyl-4-chlorophenol, 3-(4-chlorophenoxy)-propane-1,2-diol, 3-iodo-2-propinyl butyl carbamate, chlorhexidine, 3,4,4′-trichlorocarbanilide (TTC), antibacterial perfumes, thymol, thyme oil, eugenol, clove oil, menthol, mint oil, farnesol, phenoxyethanol, glycerol monocaprate, glycerol monocaprylate, glycerol monolaurate (GML), diglycerol monocaprate (DMC), salicylic acid-N-alkylamides such as, for example, salicylic acid-n-octyl amide or salicylic acid-n-decyl amide.

Enzyme Inhibitors
Suitable enzyme inhibitors are, for example, esterase inhibitors. Esterase inhibitors are preferably trialkyl citrates, such as trimethyl citrate, tripropyl citrate, triisopropyl citrate, tributyl citrate and, in particular, triethyl citrate (Hydagen® CAT). Esterase inhibitors inhibit enzyme activity and thus reduce odor formation. Other esterase inhibitors are sterol sulfates or phosphates such as, for example, lanosterol, cholesterol, campesterol, stigmasterol and sitosterol sulfate or phosphate, dicarboxylic acids and esters thereof, for example glutaric acid, glutaric acid monoethyl ester, glutaric acid diethyl ester, adipic acid, adipic acid monoethyl ester, adipic acid diethyl ester, malonic acid and malonic acid diethyl ester, hydroxycarboxylic acids and esters thereof, for example citric acid, malic acid, tartaric acid or tartaric acid diethyl ester, and zinc glycinate.

Odor Absorbers
Suitable odor absorbers are substances which are capable of absorbing and largely retaining the odor-forming compounds. They reduce the partial pressure of the individual components and thus also reduce the rate at which they spread. An important requirement in this regard is that perfumes must remain unimpaired. Odor absorbers are not active against bacteria. They contain, for example, a complex zinc salt of ricinoleic acid or special perfumes of largely neutral odor known to the expert as “fixateurs” such as, for example, extracts of ladanum or styrax or certain abietic acid derivatives as their principal component. Odor maskers are perfumes or perfume oils which, besides their odor-masking function, impart their particular perfume note to the deodorants. Suitable perfume oils are, for example, mixtures of natural and synthetic perfumes. Natural perfumes include the extracts of blossoms, stems and leaves, fruits, fruit peel, roots, woods, herbs and grasses, needles and branches, resins and balsams. Animal raw materials, for example civet and beaver, may also be used. Typical synthetic perfume compounds are products of the ester, ether, aldehyde, ketone, alcohol and hydrocarbon type. Examples of perfume compounds of the ester type are benzyl acetate, p-tert.butyl cyclohexylacetate, linalyl acetate, phenyl ethyl acetate, linalyl benzoate, benzyl formate, allyl cyclohexyl propionate, styrallyl propionate and benzyl salicylate. Ethers include, for example, benzyl ethyl ether while aldehydes include, for example, the linear alkanals containing 8 to 18 carbon atoms, citral, citronellal, citronellyloxyacetaldehyde, cyclamen aldehyde, hydroxycitronellal, lilial and bourgeonal. Examples of suitable ketones are the ionones and methyl cedryl ketone. Suitable alcohols are anethol, citronellol, eugenol, isoeugenol, geraniol, linalool, phenylethyl alcohol and terpineol. The hydrocarbons mainly include the terpenes and balsams. However, it is preferred to use mixtures of different perfume compounds which, together, produce an agreeable fragrance. Other suitable perfume oils are essential oils of relatively low volatility which are mostly used as aroma components. Examples are sage oil, camomile oil, clove oil, lemon balm oil, mint oil, cinnamon leaf oil, lime-blossom oil, juniper berry oil, vetiver oil, olibanum oil, galbanum oil, ladanum oil and lavendin oil. The following are preferably used either individually or in the form of mixtures: bergamot oil, dihydromyrcenol, lilial, lyral, citronellol, phenylethyl alcohol, α-hexylcinnamaldehyde, geraniol, benzyl acetone, cyclamen aldehyde, linalool, Boisambrene Forte, Ambroxan, indole, hedione, sandelice, citrus oil, mandarin oil, orange oil, allylamyl glycolate, cyclovertal, lavendin oil, clary oil, β-damascone, geranium oil bourbon, cyclohexyl salicylate, Vertofix Coeur, Iso-E-Super, Fixolide NP, evernyl, iraldein gamma, phenylacetic acid, geranyl acetate, benzyl acetate, rose oxide, romillat, irotyl and floramat.

Antiperspirants
Antiperspirants reduce perspiration and thus counteract underarm wetness and body odor by influencing the activity of the eccrine sweat glands. Aqueous or water-free antiperspirant formulations typically contain the following ingredients:
astringent active principles,
oil components,
nonionic emulsifiers,
co-emulsifiers,
consistency factors,
auxiliaries in the form of, for example, thickeners or complexing agents and/or
non-aqueous solvents such as, for example, ethanol, propylene glycol and/or glycerol.
Suitable astringent active principles of antiperspirants are, above all, salts of aluminium, zirconium or zinc. Suitable antihydrotic agents of this type are, for example, aluminium chloride, aluminium chlorohydrate, aluminium dichlorohydrate, aluminium sesquichlorohydrate and complex compounds thereof, for example with 1,2-propylene glycol, aluminium hydroxyallantoinate, aluminium chloride tartrate, aluminium zirconium trichlorohydrate, aluminium zirconium tetrachlorohydrate, aluminium zirconium pentachlorohydrate and complex compounds thereof, for example with amino acids, such as glycine. Oil-soluble and water-soluble auxiliaries typically encountered in antiperspirants may also be present in relatively small amounts. Oil-soluble auxiliaries such as these include, for example,
inflammation-inhibiting, skin-protecting or pleasant-smelling essential oils,
synthetic skin-protecting agents and/or
oil-soluble perfume oils.
Typical water-soluble additives are, for example, preservatives, water-soluble perfumes, pH adjusters, for example buffer mixtures, water-soluble thickeners, for example water-soluble natural or synthetic polymers such as, for example, xanthan gum, hydroxyethyl cellulose, polyvinyl pyrrolidone or high molecular weight polyethylene oxides.
   Film Formers

Standard film formers are, for example, chitosan, microcrystalline chitosan, quaternized chitosan, polyvinyl pyrrolidone, vinyl pyrrolidone/vinyl acetate copolymers, polymers of the acrylic acid series, quaternary cellulose derivatives, collagen, hyaluronic acid and salts thereof and similar compounds.

Antidandruff Agents

Suitable antidandruff agents are Pirocton Olamin (1-hydroxy-4-methyl-6-(2,4,4-trimethylpentyl)-2-(1H)-pyridinone monoethanolamine salt), Baypival® (Climbazole), Ketoconazol® (4-acetyl-1-{4-[2-(2,4-dichlorophenyl) r-2-(1H-imidazol-1-ylmethyl)-1,3-dioxylan-c4-ylmethoxyphenyl}-piperazine, ketoconazole, elubiol, selenium disulfide, colloidal sulfur, sulfur polyethylene glycol sorbitan monooleate, sulfur ricinol polyethoxylate, sulfur tar distillate, salicylic acid (or in combination with hexachlorophene), undecylenic acid, monoethanolamide sulfosuccinate Na salt, Lamepon® UD (protein/undecylenic acid condensate), zinc pyrithione, aluminium pyrithione and magnesium pyrithione/dipyrithione magnesium sulfate.

Swelling Agents

Suitable swelling agents for aqueous phases are montmorillonites, clay minerals, Pemulen and alkyl-modified Carbopol types (Goodrich). Other suitable polymers or swelling agents can be found in relevant textbooks.

Insect Repellents

Suitable insect repellents are N,N-diethyl-m-toluamide, pentane-1,2-diol and Ethyl Butyl acetylaminopropionate.

Self-Tanning Agents and Depigmenting Agents

A suitable self-tanning agent is dihydroxyacetone. Suitable tyrosine inhibitors which prevent the formation of melanin and are used in depigmenting agents are, for example, arbutin, ferulic acid, koji acid, coumaric acid and ascorbic acid (vitamin C).

Hydrotropes

In addition, hydrotropes, for example ethanol, isopropyl alcohol or polyols, may be used to improve flow behavior. Suitable polyols preferably contain 2 to 15 carbon atoms and at least two hydroxyl groups. The polyols may contain other functional groups, more especially amino groups, or may be modified with nitrogen. Typical examples are
glycerol;
alkylene glycols such as, for example, ethylene glycol, diethylene glycol, propylene glycol, butylene glycol, hexylene glycol and polyethylene glycols with an average molecular weight of 100 to 1000 dalton;
technical oligoglycerol mixtures with a degree of self-condensation of 1.5 to 10 such as, for example, technical diglycerol mixtures with a diglycerol content of 40 to 50% by weight;
methylol compounds such as, in particular, trimethylol ethane, trimethylol propane, trimethylol butane, pentaerythritol and dipentaerythritol;
lower alkyl glucosides, particularly those containing 1 to 8 carbon atoms in the alkyl group, for example methyl and butyl glucoside;
sugar alcohols containing 5 to 12 carbon atoms, for example sorbitol or mannitol,
sugars containing 5 to 12 carbon atoms, for example glucose or sucrose;
amino sugars, for example glucamine;
dialcoholamines, such as diethanolamine or 2-aminopropane-1,3-diol.
   Preservatives

Suitable preservatives are, for example, phenoxyethanol, formaldehyde solution, parabens, pentanediol or sorbic acid and the silver complexes known under the name of Surfacine® and the other classes of compounds listed in Appendix 6, Parts A and B of the Kosmetikverordnung (“Cosmetics Directive”).

Perfume Oils and Aromas

Suitable perfume oils are mixtures of natural and synthetic perfumes. Natural perfumes include the extracts of blossoms (lily, lavender, rose, jasmine, neroli, ylang-ylang), stems and leaves (geranium, patchouli, petitgrain), fruits (anise, coriander, caraway, juniper), fruit peel (bergamot, lemon, orange), roots (nutmeg, angelica, celery, cardamom, costus, iris, calmus), woods (pinewood, sandalwood, guaiac wood, cedarwood, rosewood), herbs and grasses (tarragon, lemon grass, sage, thyme), needles and branches (spruce, fir, pine, dwarf pine), resins and balsams (galbanum, elemi, benzoin, myrrh, olibanum, opoponax). Animal raw materials, for example civet and beaver, may also be used. Typical synthetic perfume compounds are products of the ester, ether, aldehyde, ketone, alcohol and hydrocarbon type. Examples of perfume compounds of the ester type are benzyl acetate, phenoxyethyl isobutyrate, p-tert.butyl cyclohexylacetate, linalyl acetate, dimethyl benzyl carbinyl acetate, phenyl ethyl acetate, linalyl benzoate, benzyl formate, ethylmethyl phenyl glycinate, allyl cyclohexyl propionate, styrallyl propionate and benzyl salicylate. Ethers include, for example, benzyl ethyl ether while aldehydes include, for example, the linear alkanals containing 8 to 18 carbon atoms, citral, citronellal, citronellyloxyacetaldehyde, cyclamen aldehyde, hydroxycitronellal, lilial and bourgeonal. Examples of suitable ketones are the ionones, α-isomethylionone and methyl cedryl ketone. Suitable alcohols are anethol, citronellol, eugenol, isoeugenol, geraniol, linalool, phenylethyl alcohol and terpineol. The hydrocarbons mainly include the terpenes and balsams. However, it is preferred to use mixtures of different perfume compounds which, together, produce an agreeable perfume. Other suitable perfume oils are essential oils of relatively low volatility which are mostly used as aroma components. Examples are sage oil, camomile oil, clove oil, melissa oil, mint oil, cinnamon leaf oil, lime-blossom oil, juniper berry oil, vetiver oil, olibanum oil, galbanum oil, ladanum oil and lavendin oil. The following are preferably used either individually or in the form of mixtures: bergamot oil, dihydromyrcenol, lilial, lyral, citronellol, phenylethyl alcohol, α-hexylcinnamaldehyde, geraniol, benzyl acetone, cyclamen aldehyde, linalool, Boisambrene Forte, Ambroxan, indole, hedione, sandelice, citrus oil, mandarin oil, orange oil, allylamyl glycolate, cyclovertal, lavendin oil, clary oil, β-damascone, geranium oil bourbon, cyclohexyl salicylate, Vertofix Coeur, Iso-E-Super, Fixolide NP, evernyl, iraldein gamma, phenylacetic acid, geranyl acetate, benzyl acetate, rose oxide, romillat, irotyl and floramat.

Suitable aromas are, for example, peppermint oil, spearmint oil, aniseed oil, Japanese anise oil, caraway oil, eucalyptus oil, fennel oil, citrus oil, wintergreen oil, clove oil, menthol and the like.

Dyes

Suitable dyes are any of the substances suitable and approved for cosmetic purposes. Examples include cochineal red A (C.I. 16255), patent blue V (C.I. 42051), indigotin (C.I. 73015), chlorophyllin (C.I. 75810), quinoline yellow (C.I. 47005), titanium dioxide (C.I. 77891), indanthrene blue RS(C.I. 69800) and madder lake (C.I. 58000). Luminol may also be present as a luminescent dye. These dyes are normally used in concentrations of 0.001 to 0.1% by weight, based on the mixture as a whole.

### EXAMPLES AND FORMULATIONS

Emulsifier Concentrate 1 (Invention):

Iso-olelyl glucoside: 50.9% by weight
Iso-oleyl alcohol: 49.1% by weight
Consistency: still liquid at 5° C.; viscosity ca. 500 mpa·s (Brookfield RVS viscosimeter; 20° C.; 10 r.p.m., spindle 4, without Helipath
   Emulsifier Concentrate 2 (Comparison):
Cetearyl glucoside: 50.9% by weight
Cetearyl alcohol: 49.1% by weight

Consistency: solid at 25° C., liquid only at >60° C., cannot be processed without heating

TABLE 1
O/W multipurpose cream (1 = invention, C1 = comparison)

| Component | 1 | C1 |
|---|---|---|
| Emulsifier concentrate 1 | 5.7 | |
| Emulsifier concentrate 2 | | 5.7 |
| Cetiol ® LC | 16.0 | 16.0 |
| (Coco-Caprylate/Caprate) | | |
| Glycerin | 3.0 | 3.0 |
| Formalin solution (37%) | 0.15 | 0.15 |
| Water | to 100 | to 100 |

Preparation of Emulsions by Cold Processing

An aqueous o/w emulsion was prepared using the components mentioned in Table 1 by stirring a mixture of emulsifier concentrate 1 and Coco-Caprylate/Caprate (Cetiol® LC, Cognis BV) as the oil phase into a mixture of glycerin, formalin solution and water at 25° C. A fine-droplet emulsion with a viscosity of 24,800 mPa·s was obtained and remained stable for several months, even under temperature stress. The viscosity of the emulsion was determined with a Brookfield RVS viscosimeter (20° C., 10 r.p.m., spindle 5, with Helipath).

Preparation of Emulsions by Hot Processing (C1)

The comparison emulsion C1 can be prepared exclusively by hot processing. To this end, a mixture of emulsifier concentrate 2 and Coco-Caprylate/Caprate (Cetiol® LC, Cognis BV) was heated to 80° C. and then stirred into a glycerin/water mixture heated to 80° C. After cooling to room temperature, the emulsion was preserved with formalin solution. The emulsion obtained was inferior in its stability to the preparation according to the invention.

TABLE 2
Shower bath with lipid-layer-enhancing properties
(2 = invention, C2 = comparison)

| Component | 2 | C2 |
|---|---|---|
| Emulsifier concentrate 3 | 16.0 | |
| Plantacare ® 818 | | 16.2 |
| (C₈₋₁₄ alkyl glucoside; 50% aqueous | | |
| solution) | | |
| Monomuls ® 90-O18 | | 7.9 |
| (oleic acid monoglyceride) | | |
| Cetiol ® OE | 15.0 | 15.0 |
| (Dicaprylyl Ether) | | |
| Eutanol ® G | 5.0 | 5.0 |
| (Octyl dodecanol) | | |
| Texapon ® NSO | 15.0 | 15.0 |
| (Laurylether sulfate, Na salt) | | |
| Water | to 100 | to 100 |

Percentages = % by weight active substance or commercial product, based on the final formulation
Emulsifier concentrate 3 (invention)
Iso-oleyl glucoside: 50.6% by weight
Iso-oleylalcohol: 49.4% by weight

Foam bath formulation 2 (Table 2) according to the invention was prepared by stirring concentrate 3, dicaprylyl ether (Cetiol® OE, Cognis BV) and 2-octyl dodecanol (Eutanol® G) into a mixture of fatty alcohol ether sulfate (Texapon® NSO) and water at 25° C. A liquid milk concentrate was obtained.

Foam bath formulation C2 (Table 2) was prepared by stirring a mixture of oleic acid monoglyceride (Monomuls® 90-018, Cognis BV), dicaprylyl ether (Cetiol® OE, Cognis BV) and 2-octyl dodecanol (Eutanol® G) into a mixture of a 50% aqueous C₈₋₁₄ alkyl glucoside solution (Plantacare® 818, Cognis BV), fatty alcohol ether sulfate (Texapon® NSO) and water at 25° C. A liquid milky concentrate was obtained.

On account of its solid consistency at room temperature, emulsifier concentrate 2 cannot be incorporated in shampoo or shower bath formulations because it crystallizes out. In principle, substances that are liquid at 20° C. are suitable as lipid layer enhancers for shower bath formulations.

Performance Evaluation

Dermatological compatibility was evaluated by determining the transepidermal water loss of pig's epidermis. To this end, defined pieces of skin were treated for 30 mins. at 40° C. with 20% aqueous solutions of the foam bath formulations prepared in accordance with Example 2 (invention) and Example C2 (comparison) and the TEWL value was gravimetrically determined.

The results are set out in Table 3. The TEWL value is the ratio expressed in percent of the transepidermal water loss of an untreated sample to that of a treated sample. The lower the value, the better the dermatological compatibility.

TABLE 3
Transepidermal water loss

| Example | TEWL [%-rel.] |
|---|---|
| 2 (invention) | 1.0 |
| C2 (comparison) | 1.5 |

The preparation according to the invention shows a distinctly lower transepidermal water loss than the comparison formulation where oleic acid monoglyceride was used as a typical lipid layer enhancer. Accordingly, the formulation according to the invention has significantly better dermatological compatibility.

1-10. (cancelled).

11. An emulsifier composition comprising:
(a) from about 0.5 to 90% by weight of an isoalkenyl oligoglycoside;
(b) from about 0.5 to 90% by weight of an isoalkenyl fatty alcohol;
(c) up to about 10% by weight, water; and
(d) optionally, from about 0.1 to 30% by weight of a hydrophilic wax, all weights being based on the weight of the composition.

12. The composition of claim 11 wherein both (a) and (b) have identical isoalkenyl groups.

13. The composition of claim 11 wherein (a) is present in the composition in an amount of from about 15 to 80% by weight, based on the weight of the composition.

14. The composition of claim 11 wherein (b) is present in the composition in an amount of from about 20 to 85% by weight, based on the weight of the composition.

15. The composition of claim 12 wherein the isoalkenyl group is iso-oleyl.

16. A cosmetic or pharmaceutical composition comprising the emulsifier composition of claim 11.

17. The composition of claim 16 wherein the emulsifier composition is present in an amount of from about 0.1 to 30% by weight, based on the weight of the cosmetic or pharmaceutical composition.

18. A process for making an emulsifier composition comprising:
(a) providing a sugar;
(b) providing an excess of an isoalkenyl fatty alcohol;
(c) combining (a) and (b) to form a mixture; and
(d) subjecting the mixture to acidic acetalization, wherein an educt ratio of sugar to isoalkenyl fatty alcohol is adjusted so that a predetermined ratio of isoalkenyl oligoglycoside to isoalkenyl fatty alcohol is directly achieved after synthesis.

19. A process for making an emulsifier composition comprising:
(a) providing a sugar;
(b) providing an excess of an isoalkenyl fatty alcohol;
(c) combining (a) and (b) to form a mixture;
(d) adjusting the amount of isoalkenyl fatty alcohol present in the mixture either by distilling off the fatty alcohol or adding more fatty alcohol to the mixture in order to obtain an emulsifier composition product having a predetermined ratio of isoalkenyl oligoglycoside to isoalkenyl fatty alcohol.
